(19) United States
(12) Patent Application Publication
(10) Pub. No.: US 2025/0002684 A1
(43) Pub. Date: Jan. 2, 2025

(54) FLUOROPOLYMER COMPOSITION AND METHOD TO MAKE

(71) Applicant: Arkema Inc., King of Prussia, PA (US)

(72) Inventors: Florence Mehlmann, King of Prussia, PA (US); Francois Bargain, King of Prussia, PA (US); Lawrence H. Judovits, King of Prussia, PA (US); Azaz A. Vahora, King of Prussia, PA (US); Sara Reynaud, King of Prussia, PA (US)

(21) Appl. No.: 18/695,390

(22) PCT Filed: Sep. 28, 2022
(86) PCT No.: PCT/US2022/045005

§ 371 Date: Mar. 26, 2024

Related U.S. Application Data
(60) Provisional application No. 63/249,627, filed on Sep. 29, 2021.

(51) Int. Cl. C08K 5/17; C08F 2/26; C08F 2/30; C08F 14/22; C08J 5/18

(52) U.S. Cl. CPC C08K 5/17; C08F 2/26; C08F 2/30; C08F 14/22; C08J 5/18; C08J 2327/16

(57) ABSTRACT

Disclosed is a composition comprising a PVDF polymer, from 0.01-3% of one or more quaternary organic salts and 10 to 1000 ppm of one or more dispersing agents, having reduced optical haze, high melt temperature, and high modulus. Also disclosed is a method of preparing the composition.

### FIELD OF THE INVENTION

The invention provides a composition and method to enable fine dispersion of quaternary organic salts into fluorinated polymers. The invention provides a fluorinated polymer with high transparency, high melt temperature and high modulus.

### BACKGROUND OF THE INVENTION

It is known to make a PVDF polymer with high transparency by blending a PVDF with an acrylic polymer, or blending a PVDF with a quaternary ammonium salt. However, both approaches have been associated with a decrease of the melt temperature of the PVDF polymer, as well as a decrease in the polymer's modulus in the case of the quaternary ammonium salts.

Quaternary ammonium salts have been described in PVDF polymers to increase transparency, however have been showed to decrease the melt temperature and the modulus of the polymer. Phosphonium, imidazolium and ammonium organic salts have been described in PVDF polymers to increase the melt temperature, however no improvement in transparency has been reported.

U.S. Pat. No. 6,610,766 teaches the use of an alkyl quaternary ammonium sulfate, or sulfite, with PVDF to increase the electrical resistivity of the polymer. They also describe an increase in the transparency of PVDF. Their examples and especially FIG. 4 shows the melt temperature decreasing with increased amount of ammonium salt added.

WO2020137108A1 and WO20137116A1 further teach the use of an alkyl quaternary ammonium sulfate, or sulfite, with PVDF. The compositions achieve good transparency and suppresses yellowing in thick parts, thanks to a concentration of alkali metal in the polyvinylidene fluoride resin composition of 60 ppm or less, a concentration of hydrogen fluoride in the polyvinylidene fluoride of 5 ppm or less, and/or a proportion of heterogeneous bonding in the polyvinylidene fluoride of 4% or higher. Some examples use Kynar® PVDF resins, such as Kynar 1000HD, which contain residual surfactant having acid end-groups. There is no mention of the melt temperature of the PVDF increasing with the addition of the quaternary ammonium salt.

WO2007145668 teaches the use of onium salts with PVDF. The compositions are annealed at high temperatures and/or the onium salts are modified with nanoclays, to achieve a composition with piezoelectric properties, high melt temperature, and low flexural modulus. There is no mention of the onium salts imparting transparency to the PVDF composition.

The use of high temperature annealing in PVDF polymers is also known to increase the melt temperature of the polymers. An example is described in published work by Gregorio et al (Journal of Materials Science, 35, 2000), where they described a solid state alpha-to-gamma phase transformation at temperatures of at least 155° C. for a homopolymer of PVDF, which is about 10-20° C. lower than the standard melt temperature of the PVDF in the alpha phase. The alpha-to-beta phase transformation increases the melt temperature by 5-10° C. Annealing treatment can be used to improve transparency of PVDF.

WO15048697 teaches the use of ammonium and phosphonium salts with PVDF that contains residual surfactant having acid end-groups. The salt is said to react with the acid end groups and improve the color stability the product after melt processing. A preferred family of salts are quaternary ammonium halides. There is no mention on the effect of the salts on transparency, melt temperature, or modulus of the polymer.

The problem faced was to provide a PVDF polymer with high transparency and high melting point and maintain at least 65%, preferably 70%, more preferably 75% of the modulus, preferably the storage modulus. Known ways to make a PVDF with high transparency include blending a PVDF with an acrylic polymer, or blending a PVDF with a quaternary ammonium salt. Both approaches have been associated with a decrease of the melting point of the PVDF polymer, and a decrease of other properties such as the modulus of the polymer.

Surprisingly, we found that when a PVDF polymer is combined with quaternary salts, and suitable dispersing agents are present—preferably copolymers containing blocks of ethylene oxide and propylene oxide or salts of the sulfate and sulfonate types—the resulting polymer has high transparency (Haze at 1 mm less than 40%), the melting point is at least 2° C. higher than the initial PVDF polymer, and up to 7 C higher, and the modulus is retained to at least 65% preferably at least 75% of the initial PVDF polymer.

### SUMMARY OF THE INVENTION

This invention is a composition and a method to provide a PVDF (“polyvinylidene fluoride”) polymer composition with high transparency, high melt temperature, and high modulus by modifying the PVDF polymer with a quaternary organic salt in the presence of a dispersing agent.

Surprisingly, we have now found that modifying a PVDF polymer with a quaternary organic salt in the presence of a dispersing agent reduces optical haze to less than 40% (1 mm thick part), retains greater than 65% of the modulus and raises the melt temperature of the PVDF polymer by at least 2° C., therefore enabling a higher service temperature for the material. Without being bound by theory, it is believed that the dispersing agent is necessary to assist the diffusion of the quaternary organic salt to the interface of amorphous and crystal domains of the PVDF polymer, therefore maximizing its nucleating effect on the transparency of the polymer, without the negative effects on melt temperature and modulus that were previously described.

The invention relates to a high transparency, high melt temperature, high modulus polyvinylidene fluoride composition comprising: a) a polyvinylidene fluoride polymer, b) from 10 ppm to 1000 ppm by weight dispersing agent based on the weight of the polyvinylidene fluoride polymer, and c) from 01 to 3 wt % of one or more quaternary organic salts (nucleating additive) based on the weight of the polyvinylidene fluoride polymer. The composition preferably comprises greater than 60 wt %, preferably greater than 80 wt % and more preferably greater than 90 wt % PVDF polymer based on total solids in the composition.

The invention provides a method to produce fluoropolymers with low optical haze, high melt temperature and high modulus, that comprises adding a quaternary organic salt (nucleating additive) to the fluoropolymer with a dispersing agent present in the composition. The invention also provides methods of making the composition with the low optical haze of less than 40%, preferably less than 35%, more preferable less than 30%, when measured by ASTM D1003 on a 1 mm part compression molded using the composition. We have found that select quaternary organic salts in conjunction with a dispersing agent that is not fluorinated and does not contain acid groups, can be used efficiently in PVDF polymers resulting in reduced optical haze and more surprisingly increased melt temperature and high modulus retention of the polymer. The invention provides the use of dispersing agents to facilitate the diffusion of quaternary organic salts within the polymer composition. Since the PVDF polymers are hydrophobic, especially in the case of some PVDF copolymers, the dispersion of quaternary organic salts is a challenge. Poor dispersion of the quaternary organic salts can lead to high optical haze, due to the size of the quaternary organic salts itself in the final material. The dispersing agent allows for the quaternary organic salts to be present in the composition as small particles and to diffuse to the interface of amorphous and crystalline domains of the PVDF polymer.

### Aspects of the Invention

Aspect 1: A resin composition comprising
a. a vinylidene fluoride polymer wherein VDF makes up more than 60 wt % of all monomer units, preferably more than 70 wt % of all monomer units, and
b. 0.1-3 wt % of one or more quaternary organic salts based on the weight of the polyvinylidene fluoride polymer, and
c. 10 to 1000 ppm (weight by weight) of one or more amphiphilic dispersing agents, wherein said dispersing agent does not contain any fluorine atoms or acid group,
   wherein the optical haze of a 1 mm thick part made by compression molding at 230° C. is less than 40% per ASTM D1003.

Aspect 2: The composition of aspect 1 wherein said resin composition has a melt temperature of at least 2° C. higher than the same PVDF resin composition without the quaternary organic salt, and has a modulus retention of at least 65%, as compared to the same composition without the quaternary organic salt.

Aspect 3: The composition of aspect 1 or 2 wherein the vinylidene fluoride polymer is a homopolymer or a copolymer having at least one comonomer selected from the group consisting of hexafluoropropene, 2,3,3,3-tetrafluoropropylene, and 3,3,3-trifluoropropene.

Aspect 4: The composition of any one of aspects 1-3 wherein the vinylidene fluoride polymer is a copolymer comprising hexafluoropropylene.

Aspect 5: The composition of any one of aspects 1-4 comprising a total of 0.2-3 wt % of quaternary organic salts, more preferably from 0.3 to 2 wt %, based on the total weight of a+b+c.

Aspect 6: The composition of any one of aspects 1-5 comprising a total of 10 ppm-500 ppm of dispersing agents based on the total weight of a+b+c.

Aspect 7: The composition of any one of aspects 1-6 wherein optical haze of a 1 mm thick part made by compression molding at 230° C. is less than 35%, more preferably less than 30%.

Aspect 8: The composition of any one of aspects 1-7 wherein the melt temperature of resin composition is least 3° C. above and more preferably at least 5C above the melt temperature of the same composition without the quaternary organic salt.

Aspect 9: The composition of any one of aspects 1-8 wherein the composition has a modulus retention at least 70%, more preferable at least 75%, as compared to the same composition without the quaternary organic salt.

Aspect 10: The composition of any one of aspects 1-9 wherein said dispersing agent is selected from the group consisting of:
non-ionic block copolymers containing segments of polyethylene glycol, polypropylene glycol and/or polytetramethylene glycol with repeating units of 2 to 200 per a block,
Poly(ethylene oxide) (PEO) and poly(propylene oxide) (PPO), arranged in an A-B-A triblock structure, with repeating units of 2 to 200 per a block,
alkyl phosphonate salts, polyvinylphosphonate salts, polyvinyl sulfonate salts, C7-C20 alkanesulfonate,
alkyl aryl sulfonate, aryl sulfonates,
alkanesulfate salts,
   and combinations thereof.

Aspect 11: The composition of any one of aspects 1 to 10 wherein said dispersing agent is a block copolymer and comprises at least one block of poly(ethylene glycol) or at least one block of poly(propylene glycol).

Aspect 12: The composition of any one of aspects 1 to 10 wherein said dispersing agent comprises a block copolymer having poly(propylene glycol)-block-poly(ethylene glycol)-block-poly(propylene glycol) group.

Aspect 13: The composition of any one of aspects 1 to 10 wherein said dispersing agent comprises at least one of sodium lauryl sulfate, sodium laureth sulfate, sodium octyl sulfate, potassium lauryl sulfate, ammonium lauryl sulfate, sodium octyl sulfonate, potassium octyl sulfonate, ammonium octyl sulfonate, and mixtures thereof.

Aspect 14: The composition of any one of aspects 1 to 13 wherein said quaternary organic salt is selected from the group consisting of quaternary ammonium salts, quaternary phosphonium salt, and combinations thereof

Aspect 15: The composition of any one of aspects 1 to 13 wherein said quaternary organic salt is selected from the group consisting of tetrabutyl ammonium bisulfate, heptyltriphenylphosphoniumbromide, (2-Hydroxyethyl)triphenylphosphoniumbromide, (4-Carboxybutyl)triphenylphosphoniumbromide, and tetrabutylammonium tetrafluorobate and combinations thereof.

Aspect 16: A method of preparing the composition of any of aspects 1 to 15 comprising the steps of
a. Providing a PVDF polymer,
b. Mixing quaternary organic salt with dispersing agent
c. Mixing the blend of b) with the PVDF polymer of a,
   wherein the amount of quaternary organic salt is at least 0.1 and no more than 3% by weight based on the weight of total dry composition and wherein the amount of dispersing agent in the final composition is from 10 ppm-1000 ppm (by weight) based on the weight of total dry composition.

Aspect 17: A method of preparing the composition of anyone of aspects 1 to 15 including the steps
d. providing a composition having PVDF polymer and dispersing agent in the form of a latex
e. blending quaternary salt with the latex to form a blend,
f. drying the blend of e into a solid material
   wherein the amount of quaternary organic salt is at least 0.1 and no more than 3% by weight based on the weight of total dry composition and wherein the amount of dispersing agent in the final composition is from 10 ppm-1000 ppm (by weight) based on the weight of total dry composition.

Aspect 18: A method of preparing the composition of anyone of aspects 1 to 15 including the steps
g. providing a composition having PVDF polymer and dispersing agent as a latex
h. drying the latex into a solid material, and
i. blending quaternary salt in with the PVDF composition of g,
   wherein the amount of quaternary organic salt is at least 0.1 and no more than 3% by weight based on the weight of total dry composition and wherein the amount of dispersing agent in the final composition is from 10 ppm-1000 ppm (by weight) based on the weight of total dry composition.

Aspect 19: An article comprising the composition of any one of aspects 1 to 15, where said article can be a film, sheet, rod, or multilayer part.

Aspect 20: The article of aspect 18 wherein the article is a melt processed article.

### DESCRIPTION OF THE INVENTION

The references cited in this application are incorporated herein by reference.

Percentages, as used herein are weight percentages, unless noted otherwise, and molecular weights are weight average molecular weights, unless otherwise stated. Melt viscosity (MV) is measured at 230° C. at 100 sec-1 using ASTM D-3835

“Copolymer” is used to mean a polymer having two or more different monomer units. “Polymer” is used to mean both homopolymer and copolymers. For example, as used herein, “PVDF” and “polyvinylidene fluoride” is used to connote both the homopolymer and copolymers, unless specifically noted otherwise. Polymers may be straight chain, branched, star, comb, block, or any other structure. The polymers may be homogeneous where a majority of polymer chains have similar distribution of comonomer units, heterogeneous where different polymer chains can have largely different distribution of comonomer units and some chains may have no comonomer units, and may be gradient where the polymer chains that have a gradient distribution of co-monomer units along the chain.

Amphiphilic means a molecule having both hydrophobic (nonpolar) and hydrophilic (polar) regions. Common examples of amphiphilic compounds are those known to be good surfactants in water-based colloidal system, for instance in emulsion or suspension polymerization.

### PVDF Polymers

PVDF homopolymers or copolymers are used in the invention.

The term PVDF copolymers denotes copolymers of vinylidene fluoride (VDF) containing one or more other fluorinated comonomers or non fluorinated comonomers, preferably fluorinated. The PVDF copolymers of the invention are those in which vinylidene fluoride units comprise greater than 60 percent of the total weight of all the monomer units in the polymer, more preferably comprise greater than 70 percent of the total weight of the units, and most preferably comprise greater than 75 percent of the total weight of the units. The fluorinated comonomer(s) preferably comprises at least 0.5%, preferably at least 1%, more preferably at least 4% by weight of the PVDF copolymer. The fluorinated comonomer(s) are preferably from 0.5% to 30 wt percent, more preferably from 1% to 20 wt %.

Fluorinated comonomers are chosen from compounds containing a vinyl group capable of opening in order to be polymerized and that contains, directly attached to this vinyl group, at least one fluorine atom, at least one fluoroalkyl group or at least one fluoroalkoxy group except VDF as it is already present in the PVDF copolymer. Examples of fluorinated comonomers include, but are not limited to vinyl fluoride; trifluoroethylene (VF3); chlorotrifluoroethylene (CTFE); 1,2-difluoroethylene; tetrafluoroethylene (TFE); hexafluoropropylene (HFP); 2,3,3,3-tetrafluoropropylene; 1,3,3,3-tetrafluoropropylene; 3,3,3-trifluoropropylene; perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD). Preferred PVDF copolymers include copolymers of copolymers of VDF and HFP, copolymers of VDF and 2,3,3,3-tetrafluoropropylene, copolymers of VDF and 3,3,3-trifluoropropylene, terpolymers of VDF, HFP, and TFE.

The PVDF copolymer can be a copolymer of VDF and HFP. In one embodiment, the copolymer has from at least 1% up to 30%, preferably up to 25%, and more preferably up to 15% by weight of hexafluoropropene (HFP) units.

The PVDF copolymer can have at least 70 wt %, preferably at least 75 wt %, more preferably at least 85 wt % by weight of VDF units.

The PVDF copolymer for use in the invention has a high molecular weight. By high molecular weight, as used herein is meant having a melt viscosity of greater than 1.0 kilopoise, preferably greater than 5 kilopoise, more preferably greater than 10 kilopoise, according to ASTM method D-3835 measured at 230° C. and 100 sec⁻¹.

The PVDF copolymer used in the invention is generally prepared by means known in the art, using aqueous free-radical emulsion polymerization—although suspension, solution and supercritical CO₂ polymerization processes may also be used.

In a general emulsion polymerization process, a reactor is charged with deionized water, water-soluble surfactant capable of emulsifying the reactant mass during polymerization and optional paraffin wax antifoulant. In some polymerizations, no surfactant is used. The mixture is stirred and deoxygenated. A predetermined amount of chain transfer agent, CTA, is then introduced into the reactor, the reactor temperature raised to the desired level and vinylidene fluoride and optionally one or more comonomers are fed into the reactor. Once the initial charge of vinylidene fluoride and optional comonomers is introduced and the pressure in the reactor has reached the desired level, an initiator emulsion or solution is introduced to start the polymerization reaction. The temperature of the reaction can vary depending on the characteristics of the initiator used and one of skill in the art will know how to do so. Typically, the temperature will be from about 30° to 150° C., preferably from about 60° to 120° C. Once the desired amount of polymer has been reached in the reactor, the monomer feed will be stopped, but initiator feed is optionally continued to consume residual monomer. Residual gases (containing unreacted monomers) are vented and the latex recovered from the reactor.

The surfactant used in the polymerization are non-fluorosurfactants known in the art to be useful in PVDF emulsion polymerization. The PVDF polymer emulsion of the invention is fluorosurfactant free, with no fluorosurfactants being used in any part of the polymerization. The surfactant used in the polymerization also do not contain any acid groups, as such groups have been showed to have poor interaction with the quaternary organic salts of the invention, and prevents the desired property improvement for the PVDF polymer. Non-fluorinated, non-acid containing surfactants useful in the PVDF polymerization of this invention could be both ionic and non-ionic in nature including, but are not limited to sodium alkyl sulfate, sodium aryl sulfate, sodium alkyl sulfonate, sodium aryl sulfonate, polyvinyl sulfonate, polyethylene glycol and/or polypropylene glycol and the block copolymers thereof, and siloxane-based surfactants. In one embodiment, the emulsion polymerization is surfactant-free.

The PVDF polymerization results in a latex generally having a solids level of 10 to 60 percent by weight, preferably 10 to 50 percent, and having a latex volume average particle size of less than 500 nm, preferably less than 400 nm, and more preferably less than 300 nm. The discrete volume average particle size is generally at least 20 nm and preferably at least 50 nm.

A minor amount (preferably less than 10 wt percent, more preferably less than 5 wt %) of one or more other water-miscible solvents, such as ethylene glycol, may be mixed into the PVDF latex to improve freeze-thaw stability.

The PVDF latex may be used in the invention process as a latex, or it may be first dried to a powder by means known in the art, such as, but not limited to, spray drying, freeze-drying, coagulating, and drum drying.

In some embodiments, copolymers of VDF and HFP are used. In some embodiments homopolymers of VDF are used.

It is preferred that no other fluorinated molecules are present in the composition except the PVDF polymer.

### Quaternary Organic Salt

The quaternary organic salt acts as a nucleating additive for the PVDF.

Quaternary organic salt is used in an amount of from 0.1-3 wt %. Quaternary organic salts contain a quaternary cation center that forms four covalent bonds, each bond is to an alkyl or aryl group. The quaternary cation center can be ammonium, phosphonium, or pyridinnidium. Examples of quaternary organic salts include alkyl and aryl ammonium salts, alkyl and aryl phosphonium salts, alkyl and aryl pyridinnidium salts, tetrabutyl ammonium bisulfate, heptyltriphenylphosphoniumbromide, (2-Hydroxyethyl)triphenylphosphoniumbromide, (4-Carboxybutyl)triphenylphosphoniumbromide, and tetrabutylammonium tetrafluorobate.

There can be one or more quaternary organic salt present. The total amount of quaternary organic salt in the present invention will be at least 0.1 and no more than 3% by weight based on the total composition. The amount of any one quaternary organic salt can be from 0.1-3%, preferably from 0.2 to 3%, more preferably from 0.3 to 2% by weight based on the total composition.

### Dispersing Agent

The amount of dispersing agent present in the composition of the invention is from 10 ppm-1000 ppm (by weight) of one or more dispersing agents, preferably from 10 ppm to 500 ppm, based on the total composition. The dispersing agent is amphiphilic. The term “dispersing agent’ means a type of molecule which has both hydrophobic and hydrophilic, portions, which allows it to stabilize and disperse hydrophobic molecules and aggregates of hydrophobic molecules in aqueous systems.

The dispersing agent does not include compounds containing fluorine atoms. The dispersing agent does not include compounds containing an acid group.

The dispersing agent are non-fluorinated compounds. That is the dispersing agents do not contain any fluorine atoms. Fluorinated compounds don't provide for good dispersion of nucleating additive. Fluorinated dispersing agents have too much affinity for the fluoropolymer and therefore will not act as an aid for dispersion of the quaternary organic salt.

In acid containing dispersing agents, the acid group is too polar and does not have enough affinity with the PVDF resin and therefore does not work as a dispersing agent for the present invention, it is actually detrimental to the dispersion of quaternary organic salt.

Examples of the non-fluorinated, non acid-containing dispersing agent include:
non-ionic block copolymers containing segments of polyethylene glycol, polypropylene glycol and/or polytetramethylene glycol with repeating units of 2 to 200 per a block, Poly(ethylene oxide) (PEO) and poly(propylene oxide) (PPO), arranged in an A-B-A triblock structure, with repeating units of 2 to 200 per a block,
alkyl phosphonate salts, polyvinylphosphonate salts, polyvinyl sulfonate salts,
C7-C20 alkanesulfonate,
alkyl aryl sulfonate, aryl sulfonates,
alkanesulfate salts,
and combinations thereof.

For Non-ionic block copolymers containing segments of polyethylene glycol, polypropylene glycol and/or polytetramethylene glycol, the repeating unit is preferably 3 to 100 in each block, and the terminal groups are preferably selected from hydrogen, hydroxyl, carboxyl, ester, ether and/or hydrocarbon. Poly(ethylene oxide) (PEO) and poly(propylene oxide) (PPO), arranged in an A-B-A triblock structure, with repeating units of 2 to 200 per a block thus giving PEO-PPO-PEO is also preferred.

Ionic dispersing agents exclude quaternary organic salts containing a quaternary cation center having four covalent bonds to alkyl or aryl groups, such as ammonium, phosphonium, pyridinnidium. Quaternary ammonium cations are positively charged polyatomic ions of the structure NR⁺₄, R being an alkyl group or an aryl group. None of the 4 bonds is to a hydrogen. Unlike the ammonium ion (NH₄⁺) and the primary, secondary, or tertiary ammonium cations, the quaternary ammonium cations are permanently charged, independent of the pH of their solution.

The ammonium cations for the dispersing agents used in the invention include NH₄, and mono alkyl, dialkyl, and trialkyl, and ammonium ions, with the alkyl parts of the monoalkyl, dialkyl, or trialkyl, ammonium ions each independently having from C1 to C20 alkyl groups, preferably each alkyl group independently having from one to four carbon atoms. For alkyl phosphonate salts, polyvinylphosphonate salts, polyvinyl sulfonate salts, examples include but are not limited to ammonium octyl phosphonate, ammonium dodecyl phosphonate, sodium octyl phosphonate, sodium dodecyl phosphonate, salts of polyvinylphosphonate such as sodium, potassium or magnesium salts, salts of polyvinyl sulfonate such as sodium, potassium or magnesium salts.

Alkanesulfonate salts include but are not limited to C7-C20 linear 1-alkanesulfonates, C7-C20 linear 2-alkanesulfonates, C7-C20 linear 1,2-alkanedisulfonates, and mixtures thereof;

Alkyl aryl sulfonate include but are not limited sodium or ammonium dodecyl benzene sulfonate (SDDBS). The alkyl group can be from C1 to C20. The aryl group is generally benzene or a benzene derivative.

Alkanesulfate salts (also referred to as alkyl sulfate salts) follow the general structure such as R—OSO-M or MO₃SO—R—OSO₃M; where R is a hydrocarbon group, and M is a monovalent cation preferably selected from the group consisting of alkali metal ions, ammonium ions and mono alkyl, dialkyl, and trialkyl, and ammonium ions, with the alkyl parts of the monoalkyl, dialkyl, or trialkyl, ammonium ions each independently having from C1 to C20 alkyl groups, preferably each alkyl group independently having from one to four carbon atoms. The preferred M are selected from sodium, potassium and ammonium. Examples include but are not limited to sodium lauryl sulfate, sodium octyl sulfate, potassium lauryl sulfate, ammonium lauryl sulfate, sodium laureth sulfate and mixtures thereof.

Particularity preferred dispersing agents comprise blocks of PEG and PPG, for example Poly(propylene glycol)-block-poly(ethylene glycol)-block-poly(propylene glycol) PPG-PEG-PPG or PEO-PPO-PEO An example of this type of surfactant is available under the trademark PLURONIC.

### Mixing Process

The PVDF polymer is produced in the presence of a non-fluorinated, non-acid containing dispersing agent or in a surfactant free process and in general, the polymer composition will contain residual dispersing agent when used. Optionally, additional dispersing agent can be added to the polymer composition after the polymerization process. The addition of dispersing agent is optional if there is sufficient residual dispersing agent present in the PVDF polymer from the polymerization process. Optionally, the residual dispersing agent used to produce the polymer is washed out of the polymer, and the same or a different dispersing agent is added to the polymer after the polymerization process. The PVDF polymer, the quaternary organic salt and the dispersing agent (residual from polymerization and/or post added) can be mixed in an aqueous media followed by drying into a particulate material, or they can be mixed as solid (“dry”) materials. The components can be blended in any order or simultaneously. Dispersion agents can be mixed with the PVDF polymers and quaternary organic salt in one step, or can be first mixed with the quaternary organic salt, then subsequently mixed with the PVDF polymers, or can be first mixed with the PVDF polymers, then subsequently mixed with the quaternary organic salt. Any mixing equipment known in the art can be utilized, including static mixers, brabenders, extruders.

In one embodiment, a blend of the PVDF polymer, quaternary organic salt and dispersing agent can be prepared by co-spray drying the components mixed in an aqueous media. One could mix together an effective amount of PVDF polymer latex with quaternary organic salt (in latex, solution, or solid form), and with residual and/or post added dispersing agent (in latex, solution, or solid form), and co-spray them to achieve a dry powder that is well mixed at nano-scale. This co-spray dried complex can then be processed into the desired shape by any melt process know in the art, such as compression molding, injection molding, extrusion, coextrusion. Use of PVDF latex with small particle size (generally 20-400 nm) to make the inventive blend provides an extremely intimate blend that allows for excellent dispersion of the nucleating additive in the material and helps further reduce the optical haze.

### Characterization of the Inventive Composition

The optical haze value of the inventive polymer composition is less than 40%, preferably less than 35%, more preferably less than 30%, when measured on a 1 mm thick PVDF part containing the dispersing agent and quaternary organic salt

The melt temperature of the inventive polymer composition is at least 2° C., preferably 3° C. and more preferably at least 5° C. above the melt temperature of the same composition without the quaternary organic salt.

The modulus of the composition of the invention containing the dispersing agent and the quaternary organic salt has a modulus (preferably storage modulus) retention of at least 65%, preferably more than 70% and even more preferably more than 75% as compared to the same composition without the quaternary organic salt.

It was unexpected that the invention composition would have an increased melt temperature and be able to retain greater than 65% of it modulus as well as having reduced optical haze. Having all three characteristics is novel, because typically improving one characteristic would result in a detriment of another of the characteristics.

### Uses

Due to the advantageous properties of PVDF polymers, including chemical inertness, biological purity, and excellent mechanical and thermo mechanical properties, now combined with consistent low haze, high melt temperature and high modulus, the composition of this invention can find use in many applications.

The composition of the present invention are melt processed to produce articles. The articles of the present invention are melt processed articles.

Some articles made with the composition of the invention include, but are not limited to films, sheet, rods, pipes, tubes, multilayer parts.

### EXAMPLES

### Test Methods:

Optical haze is measured per ASTM D1003, and is reported as percent optical haze for a part of given thickness. A 1 mm thickness was used in the examples.

Melt temperature is measured by differential scanning calorimetry (DSC), using a Q2000 unit from TA Instruments and ASTM E794. The DSC runs are cycled twice at 10° C./min from negative 75° C. (198 Kelvin) to 210° C., and the melt temperature is reported as the peak melt temperature (lowest temperature peak in case of more than one peak) during the second heat cycle. A material containing both a nucleating agent and a dispersion aid (Material X) is compared to the same material that does not contain the nucleating agent (Material Y). The increase or decrease of melt temperature is calculated as the difference between the melt temperature of Material X and the melt temperature of Material Y. It is expressed in Celsius degrees (° C.).

Modulus at room temperature is determined by different methods to measure either the Young modulus or the storage modulus. Young modulus is measured using an Instron 4202 instrument or a TA Instruments RSA-G2 analyzer in tensile mode per ASTM D638. Storage modulus is obtained from dynamic mechanical analysis (DMA) using a TA Instruments ARES RDA Ill in torsional mode per ASTM D5279, with a heating ramp of 5° C./min. A material containing both a nucleating agent and a dispersion aid (Material X) is compared to the same material that does not contain the nucleating agent (Material Y). The retention of modulus is calculated as the ratio of the modulus of Material X and the modulus of Material Y. It is expressed as a percentage.

### Example 1

A PVDF homopolymer containing 300 ppm Pluronic block copolymer of polyethylene glycol and polypropylene glycol, is combined with 1.5% tetrabutyl ammonium bisulfate in a twin screw extruder at 200 C to produce pellets. The pellets are compression molded into 1 mm thick plaques at 220 C under 5MT of pressure, and cooled down to room temperature over 10 minutes. A control 1 mm plaque of the material with no tetrabutyl ammonium bisulfate is also compression molded in the same conditions. Table 1 reports optical haze, melting point and modulus for the materials. The optical haze of the material of Example 1 is 21.4%, which represents a retention of 77% versus the control. In addition, the material of Example 1 shows an increase in melting point of 4.9° C., and a modulus retention of 80-81%, as compared to the control.

### Example 2

A PVDF homopolymer containing 300 ppm of sodium 1-octanesulfonate, is combined with 1.5% tetrabutyl ammonium bisulfate in a twin screw extruder at 200 C to produce pellets. The pellets are compression molded into 1 mm thick plaques at 220 C under 5MT of pressure, and cooled down to room temperature over 10 minutes. A control 1 mm plaque of the material with no tetrabutyl ammonium bisulfate is also compression molded in the same conditions. Table 1 reports optical haze, melting point and modulus for the materials. The reduction of optical haze is 75%, the increase of melting point is 6.2° C., and the retention of storage modulus is 79-88%. The optical haze of the material of Example 2 is 24.4%, which represents a retention of 75% versus the control. In addition, the material of Example 2 shows an increase in melting point of 6.2° C., and a modulus retention of 79-88%, as compared to the control.

### Example 3

A VDF/HFP copolymer containing 300 ppm Pluronic block copolymer of polyethylene glycol and polypropylene glycol, is combined with 0.5% tetrabutyl ammonium bisulfate in a twin screw extruder at 200 C to produce pellets. The pellets are compression molded into 1 mm thick plaques at 220 C under 5MT of pressure, and cooled down to room temperature over 10 minutes. A control 1 mm plaque of the material with no tetrabutyl ammonium bisulfate is also compression molded in the same conditions. Table 1 reports optical haze, melting point and modulus for the materials. The reduction of optical haze is 79%, the increase of melting point is 6.0° C., and the retention of modulus is 88%. The optical haze of the material of Example 3 is 17.3%, which represents a retention of 79% versus the control. In addition, the material of Example 3 shows an increase in melting point of 6.0° C., and a modulus retention of 88-90%, as compared to the control.

### Example 4—Comparative

A PVDF homopolymer containing 300 ppm Zonyl1033D fluorinated amphiphilic compound, is combined with 1.5% of tetrabutyl ammonium bisulfate in a twin screw extruder at 200 C to produce pellets. The pellets are compression molded into 1 mm thick plaques at 220 C under 5MT of pressure, and cooled down to room temperature over 10 minutes. A control 1 mm plaque of the material with no tetrabutyl ammonium bisulfate is also compression molded in the same conditions. Table 1 reports optical haze, melting point and modulus for the materials. The optical haze of the material of Comparative Example 4 is 20.2%, which represents a retention of 78% versus the control. However, the melting point only increases by less than 1° C., and the retention of storage modulus is only 53%, much lower than for the examples of the invention.

TABLE 1

| | Optical | | | | | | | |
|---|---|---|---|---|---|---|---|---|
| | Haze @ | Optical | | Melt | | Storage | | Young |
| | 1 mm | Haze | Melt | temp. | Storage | modulus | Young | Modulus |
| | thickness | reduction | temp. | variation | Modulus | retention | Modulus | retention |
| Material | (%) | (%) | (° C.) | (° C.) | G′ (MPa) | (%) | E (MPa) | (%) |
| Ex. 1 | 21.4 | 77 | 174.4 | 4.9 | 607 | 81 | 1,200 | 80 |
| Ex. 1 | 94.3 | — | 169.5 | — | 746 | — | 1,500 | — |
| Control | | | | | | | | |
| Ex. 2 | 24.4 | 75 | 175.4 | 6.2 | 615 | 88 | 1,180 | 79 |
| Ex. 2 | 96.0 | — | 169.3 | — | 702 | — | 1,500 | — |
| Control | | | | | | | | |
| Ex. 3 | 17.1 | 79 | 148.4 | 6.0 | 246 | 90 | 483 | 88 |
| Ex. 3 | 81.2 | — | 142.4 | — | 273 | — | 551 | — |
| Control | | | | | | | | |
| Comp 4 | 20.2 | 78 | 170.3 | 1.3 | 453 | 53 | 900 | 60 |
| Comp 4 | 93.7 | — | 169.0 | — | 733 | — | 1,500 | — |
| Control | | | | | | | | |

1. A resin composition comprising
a. a vinylidene fluoride polymer wherein VDF makes up more than 60 wt % of all monomer units, preferably more than 70 wt % of all monomer units, and
b. 0.1-3 wt % of one or more quaternary organic salts, and
c. 10 to 1000 ppm (weight by weight) of one or more amphiphilic dispersing agents, wherein said dispersing agent does not contain any fluorine atoms or acid group
wherein the optical haze of a 1 mm thick part made by compression molding at 230° C. is less than 40% per ASTM D1003.

2. The composition of claim 1, wherein said resin composition has a melt temperature of at least 2° C. higher than the same PVDF resin composition without the quaternary organic salt, and has a modulus retention of at least 65%, as compared to the same composition without the quaternary organic salt.

3. The composition of claim 1, wherein the vinylidene fluoride polymer is a homopolymer or a copolymer having at least one comonomer selected from the group consisting of hexafluoropropene, 2,3,3,3-tetrafluoropropylene, and 3,3,3-trifluoropropene.

4. The composition of claim 1, wherein the vinylidene fluoride polymer is a copolymer comprising hexafluoropropylene.

5. The composition of claim 1, comprising a total of 0.2-3 wt % of quaternary organic salts based on the total weight of a+b+c.

6. The composition of claim 1, comprising a total of 10 ppm-500 ppm of dispersing agents based on the total weight of a+b+c.

7. The composition of claim 1 wherein optical haze of a 1 mm thick part made by compression molding at 230° C. is less than 35%.

8. The composition of claim 1, wherein the melt temperature of resin composition is least 3° C. above the melt temperature of the same composition without the quaternary organic salt.

9. The composition of claim 1, wherein the composition has a modulus retention at least 70%, as compared to the same composition without the quaternary organic salt.

10. The composition of claim 1, wherein said dispersing agent is selected from the group consisting of:
non-ionic block copolymers containing segments of polyethylene glycol, polypropylene glycol and/or polytetramethylene glycol with repeating units of 2 to 200 per a block; non-ionic block copolymers containing segments of Poly(ethylene oxide) (PEO) and poly(propylene oxide) (PPO); alkyl phosphonate salts; polyvinylphosphonate salts; polyvinyl sulfonate salts; C7-C20 alkanesulfonate; alkyl aryl sulfonate; aryl sulfonates; alkanesulfate alts; and combinations thereof.

11. The composition of claim 1, wherein said dispersing agent is a block copolymer and comprises at least one block of poly(ethylene glycol) or at least one block of poly(propylene glycol).

12. The composition of claim 1, wherein said dispersing agent comprises a block copolymer having poly(propylene glycol)-block-poly(ethylene glycol)-block-poly(propylene glycol) group or PEO-PPO-PEO group.

13. The composition of claim 1, wherein said dispersing agent comprises at least one of sodium lauryl sulfate, sodium laureth sulfate, sodium octyl sulfate, potassium lauryl sulfate, ammonium lauryl sulfate, sodium octyl sulfonate, potassium octyl sulfonate, ammonium octyl sulfonate, and mixtures thereof.

14. The composition of claim 1, wherein said quaternary organic salt is selected from the group consisting of quaternary ammonium salts, quaternary phosphonium salt, and combinations thereof

15. The composition of claim 1, wherein said quaternary organic salt is selected from the group consisting of tetrabutyl ammonium bisulfate, heptyltriphenylphosphoniumbromide, (2-Hydroxyethyl)triphenylphosphoniumbromide, (4-Carboxybutyl)triphenylphosphoniumbromide, and tetrabutylammonium tetrafluorobate and combinations thereof.

16. A method of preparing the composition of claim 1, comprising the steps of
a. Providing a PVDF polymer,
b. Mixing quaternary organic salt with dispersing agent
c. Mixing the blend of step b) with the PVDF polymer of step a,
wherein the amount of quaternary organic salt is at least 0.1 and no more than 3% by weight based on the weight of total dry composition and wherein the amount of dispersing agent in the final composition is from 10 ppm-1000 ppm (by weight) based on the weight of total dry composition.

17. A method of preparing the composition of claim 1, including the steps
d. providing a composition having PVDF polymer and dispersing agent in the form of a latex,
e. blending quaternary salt with the latex to form a blend, and
f. drying the blend of e into a solid material
wherein the amount of quaternary organic salt is at least 0.1 and no more than 3% by weight based on the weight of total dry composition and wherein the amount of dispersing agent in the final composition is from 10 ppm-1000 ppm (by weight) based on the weight of total dry composition.

18. A method of preparing the composition of claim 1, including the steps
g. providing a composition having PVDF polymer and dispersing agent as a latex
h. drying the latex into a solid material
i. blending quaternary salt in with the PVDF composition of g,
wherein the amount of quaternary organic salt is at least 0.1 and no more than 3% by weight based on the weight of total dry composition and wherein the amount of dispersing agent in the final composition is from 10 ppm-1000 ppm (by weight) based on the weight of total dry composition.

19. An article comprising the composition of claim 1, where said article can be a film, sheet, rod, or multilayer part.

20. The article of claim 19 wherein the article is a melt processed article.
